(19) United States
(12) Patent Application Publication
(10) Pub. No.: US 2006/0175524 A1
(43) Pub. Date: Aug. 10, 2006

(54) Exterior clamp slip base housing-mounting system for roadway sign post

(76) Inventor: Loren Brian Nelson, Lubbock, TX (US)

Correspondence Address: Loren Brian Nelson, 702 Woodrow Rd, Lubbock, TX, 79423, US

(21) Appl. No.: 11/037,849

(22) Filed: Jan. 18, 2005

(51) Int. Cl. F16M 13/00

(52) U.S. Cl. 248/545

(57) ABSTRACT

A cost effective, durable and safe system for mounting roadway sign posts. The system increases the durability of a sign post by its use of an exterior clamping system to hold the sign post into the base housing. This clamping system creates a tighter hold on the sign post which prevents damage to the sign post caused by rotation and movement that arises from the slack or insecure grip that occurs when a sign post is mounted with current mounting. The use of heat treated washers, in addition to the bolts and nuts required to attach the system to a ground anchor, allows for easy break away of the sign post in the event of an accident thereby increasing the overall safety for motorists. The design of the system is such that it can also be used as an inexpensive, yet secure, ground anchor upon which the mounting system can attached.

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO MATERIALS ON COMPACT DISC

Not Applicable

### BACKGROUND OF THE INVENTION

The present invention relates to the mounting and installation of roadway sign posts. Applicant has been involved with the installation and manufacture of roadway sign posts for a number of years. Through the course of such involvement, Applicant became aware of problems with the mounting systems used for the installation of sign posts. In particular, Applicant observed problems relating to the failure of mounting system, to prevent sign posts from rotating or coming loose after mounting. When a sign post rotates or becomes loose in the base, it often suffers significant damage leading to a premature and increased failure rate.

Applicant believes the problem with the looseness and rotation of sign posts is caused by inadequate mounting systems that often contain set screws or a locking ring. When set screws are used, the only direct contact points between the mounting system and the sign post are the points where the set screws touch the sign post. Such contact is inadequate to hold the sign post in place, which allows the sign post to rotate or become loose after mounting. Additionally, the set screws often damage the structural integrity of the sign post by creating indentations at the point of contact which can lead to premature failure. When a locking ring device is used, sign posts cannot be tightened strongly enough to prevent the sign post from ultimately rotating or becoming loose in the ring. Additionally, the locking ring itself can turn within the system. The present invention is designed to correct the problems caused by present day inadequate mounting systems for roadway sign posts.

### 7. BRIEF SUMMARY OF INVENTION

The present invention is a mounting system for roadway sign posts. The invention is attached to a ground anchor that is secured to the ground through concrete or other means. Once attached to the anchor, the invention serves as the base into which a sign post is mounted and is responsible for holding the sign post securely in place. The mounting system uses a clamp with exterior bolts as the primary means of holding the sign post in place after the post is inserted into the base. The clamp, which is rounded in the same dimensions as the sign post, is tightened around the sign post by two exterior bolts. The clamp and exterior bolt method of securing the sign post allows for a greater surface area contact between the mounting system and the sign post which allows for a better grip on the sign post. This eliminates the development of slack that ultimately allows the sign post to become loose and rotate in the mounting system. The fact that the exterior clamping bolts do not come into contact with the sign post prevents damage to the structural integrity of the sign post that is commonly caused by the use of set screws in mounting systems. The lack of contact between the clamping bolts and sign post also makes it much less likely for the clamping bolts to become loose.

The present invention is made with all mild steel rather than ductile castings which reduces the chance for breakage and which reduces the possibility of thread failure. The invention can also be used as a ground anchor without any modification. This is accomplished by attaching a stub to the system in the same manner as a sign post and then inverting the system so the stub can be inserted into the ground. The stub is then secured into the ground by the use of concrete or other means. Once the invention is secured to the ground as an anchor, an additional unit can then be attached to the anchor as the mounting system.

### 8. BRIEF DESCRIPTION OF THE DRAWINGS

There are four drawings submitted with the application:

Figure One is a side view of the invention in an exploded view showing how all the parts should be assembled.

Figure Two is a top view of the invention showing the clamping bolts.

Figure Three is an exploded side view of the invention being used both as a mounting system and ground anchor.

Figure Four is a side view of the invention showing a completely assembled unit when in use as both a mounting system and ground anchor.

### 9. DETAILED DESCRIPTION OF THE INVENTION

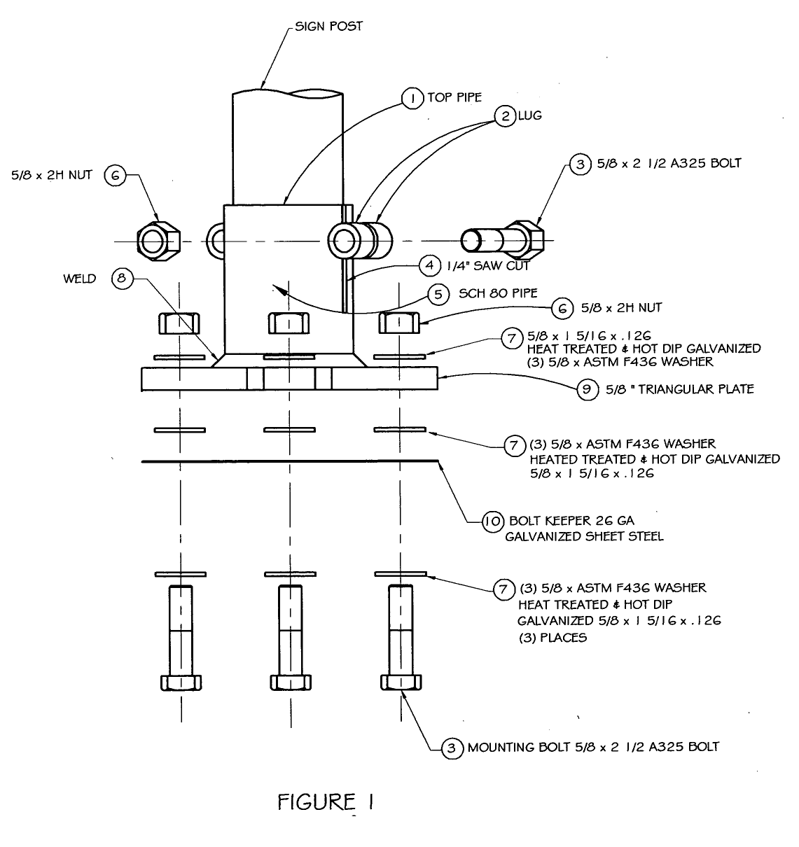

The invention is comprised of a schedule 80 pipe that is three and one half inches (3½″) in diameter and four and one half inches (4½) long. (See FIG. 1, number 5). The pipe contains two saw cuts which are located on opposite sides of each other and which run parallel with the length of the pipe. (See FIG. 1, number 4). Each saw cut is one quarter inch (¼″) wide and three inches (3″) long. (See FIG. 1, number 4).

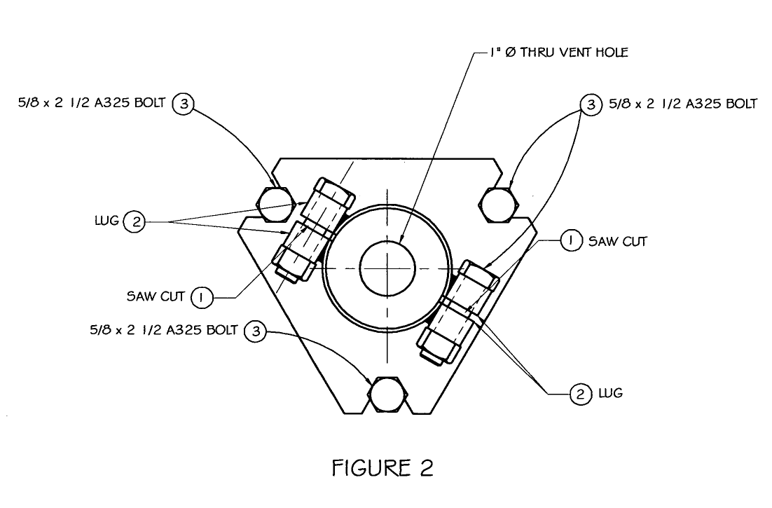

Four lugs are welded onto the pipe at the saw cuts. (See FIG. 2, number 2). Each lug is made up of one inch (1″) hot rolled steel with a twenty-one thirty-second inch ( 21/32″) hole bored through the center. Each lug is placed on the pipe so that the top of the lug is one fourth of an inch (¼″) from the top of the pipe. (See FIG. 1, number 2). The lugs are then attached to the pipe in two pairs with each pair being placed along the two saw cuts. The lugs in a pair are placed opposite one another on either side of the saw cut. (See FIG. 2, number 2). The lugs are placed along the saw cuts in such a way that the bore of each lug faces the other lug. (See FIG. 2, number 2). The lugs are positioned so that when a bolt is inserted through a pair of lugs, the bolt will run perpendicular to the direction of the saw cut. (See FIG. 1, number 3).

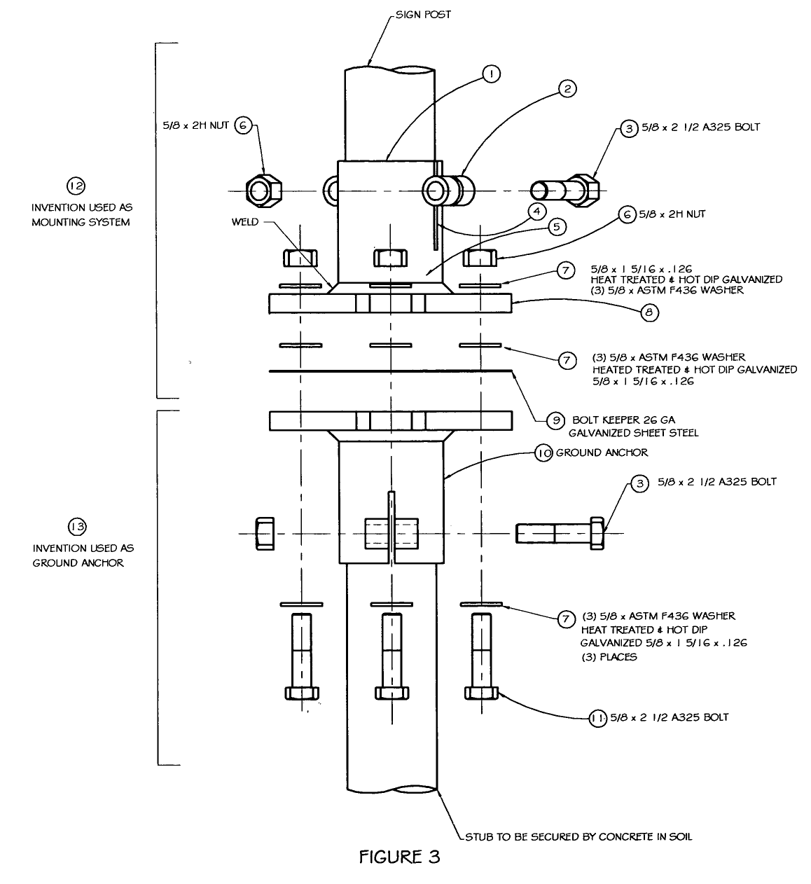

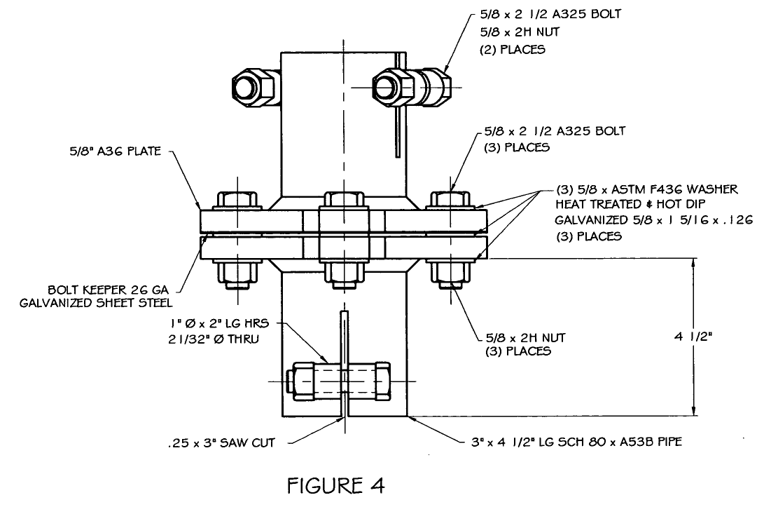

The pipe is welded to a five eighth inch (⅝″) triangular plate which complies to the standards of the Texas Universal Triangular Slip Base System. (See FIG. 1, number 9). This allows the invention to have universal application to roadway signs throughout the State of Texas and other areas using this system. The invention is completed with five bolts which are five eighths by two and one half inches (⅝″×2½″) A325 bolts, five nuts which are five eighths of an inch (⅝″) by 2H nuts, six washers which are five eighths by one and five sixteenths inch (⅝″×1 5/16″) by 0.126″ ASTM F 436 washers (heat treated and hot dipped galvanized) and a 26 gauge galvanized sheet steel bolt keeper. (See FIG. 1 numbers 3, 6, 7, and 10). Three bolts are used to attach the base to a ground anchor with the bolts, washers and sheet steel placed as shown in FIG. 3, numbers 6-11. When mounting the base to the anchor, the bolts should be torqued to 85FTLB torque. The use of the heat treated washers and sheet metal allow the sign post to be securely mounted but still maintain the ability to break away easily from the base in case of an accident for added safety to motorists. The remaining two bolts serve as clamping bolts and are inserted into the lugs. (See FIG. 1, number 3). Once a sign post has been placed into the housing of the slip base, the clamping bolts are tightened around the sign post with the remaining two nuts to 150 FTLB torque. (See FIG. 1, numbers 3 and 6).

When used as a mounting system, the invention will be attached to an existing ground anchor and a sign post will then be placed into the base and secured by the two clamping bolts. The invention is designed in such a way, however, that it can also be used as the ground anchor upon which the system may be mounted. (See FIG. 3, number 13). In order for the invention to be used as a ground anchor, a piece of two and one half inch (2½″) schedule 80 pipe, approximately thirty six inches (36″) long is placed into the base and tightened with clamping bolts to 150 FTLB torque. The invention is then inverted so that the 36″ pipe is concreted into the ground. Once it is secured into the ground, another unit can be mounted onto it to serve as the mounting system for a sign post.

1) The use of a clamp with exterior bolts that is formed in the same shape as the sign post allows for a complete surface area contact between the mounting system and the sign post resulting in a stronger grip with no slack. This prevents the development of slack and prevents the sign post from rotating or rocking in the mounting system.

2) The use of a clamp with exterior bolts avoids deformation and damage to the sign post by allowing smooth contact between the sign post and the mounting system.

3) The use of a clamp with exterior bolts to hold the sign in place eliminates any direct contact between the bolts and sign post thereby preventing the bolts from coming loose.

4) The use of a clamp with exterior bolts to hold the sign in place eliminates any direct contact between the bolts and the sign post thereby preventing the bolts from causing any damages to the structural integrity of the sign post.

5) The inside bore of the mounting system is not tapered which allows for complete and direct contact between the mounting system and the sign post for the entire length of the inside bore.

6) The design of the mounting system, in particular, the use of a clamp with exterior bolts and the use of identical bolts for both the clamping system and for attachment to the ground anchor, allows for easy installation of the mounting system onto the ground anchor and of the sign post onto the mounting system.

7) The design of the mounting system allows for the easy installation of the sign post as the post can be placed and positioned into the mounting system after the mounting system has been attached to a ground anchor.

8) The mounting system is fabricated from all mild steel as opposed to ductile cast iron which prevents the failure of threads and breakage caused by the use of ductile cast iron.

9) The mounting system uses five nuts and bolts, all of the nuts and bolts being of one size such that installation can be accomplished with only two wrenches or socket devices.

10) The mounting system can be used as an effective ground anchor without any modification to the system simply by inverting the system and attaching a stub that is then secured to the ground by concrete or other means.

11) The use of heat treated washers, in addition to the bolts and nuts required to attach the system to a ground anchor, allows for easy break away of the sign post in the event of an accident thereby increasing the overall safety for motorists.
